(19) United States
(12) Patent Application Publication
(10) Pub. No.: US 2007/0041176 A1
(43) Pub. Date: Feb. 22, 2007

(54) Pair of shining swimming goggles

(76) Inventor: Hsiu-Ying Sung, Taipei (TW)

Correspondence Address: HSIU-YING SUNG, P.O. BOX 26-757, TAIPEI, 106, TW

(21) Appl. No.: 11/208,403

(22) Filed: Aug. 22, 2005

(51) Int. Cl. F21V 21/084

(52) U.S. Cl. 362/105; 362/234; 362/800

(57) ABSTRACT

A pair of shining swimming goggles comprises a pair of swimming goggles, a shining module and an electric conducting portion. The shining module is embedded in an inner portion of the swimming goggles. The electric conducting portion is disposed on a surface of the swimming goggles. The electric conducting portion is electrically connected to the shining module, thereby when the swimming goggles are placed in water, the electric conducting portion conducts electricity to the shining module by water to make the shining module shine for showing the position of the swimmer.

### BACKGROUND OF THE INVENTION

1. Field of the Invention

The present invention relates to a pair of shining swimming goggles, and more particularly, to a pair of swimming goggles that will shine in water.

2. Description of the Related Art

Referring to FIG. 1, a pair of conventional swimming goggles comprises two lens bodies 1a, two linings 13a, a bridge component 2a and a goggles band 3a.

The lens bodies 1a are made of transparent or translucent plastic material, and are left and right symmetric. Lock ears 15a are provided at the adjacent ends of the left and right lens bodies 1a. Each of the lens bodies 1a has a lens portion 11a. Side frame portions 12a extend from the peripheries of the lens portions 11a to the eye socket-sticking sides of the swimming goggles. Goggles band holes 14a are provided at the side frame portions 12a at the distant ends of the left and right lens bodies 1a.

Two ends of the bridge component 2a are connected to the adjacent ends of the two lens bodies 1a. The two ends of the bridge component 2a pass through the lock ears 15a of the left and right lens bodies 1a and fasten thereon for adjusting the distance between the two lens bodies 1a.

Two ends of the goggles band 3a pass through and are connected to the goggles band holes 14a at the distant ends of the two lens bodies 1a.

However, the above-mentioned conventional swimming goggles do not provide a light source that allows the position of the swimmer in water to be observed easily. If a swimmer has an accident in water, it is difficult for a lifesaver to locate the swimmer straight away. In order to ensure the swimmer's security, it is necessary to embed a shining module in the swimming goggles so that a lifeguard can quickly ascertain the position of the swimmer.

Therefore, the conventional swimming goggles are limited by its design in only protecting a swimmer's eyes. It does not provide a function for showing the swimmer's position to preserve their life and safety.

### SUMMARY OF THE INVENTION

It is therefore a principal object of the present invention to provide a pair of shining swimming goggles, which shine in water, for showing the swimmer's position to preserve their life and safety.

To achieve the above object, one feature of the present invention is a pair of shining swimming goggles, comprising a pair of swimming goggles, a shining module embedded in an inner portion of the swimming goggles, and an electric conducting portion disposed on a surface of the swimming goggles and electrically connected to the shining module. Thereby when the swimming goggles are in water the electric conducting portion conducts power to the shining module, and the shining module shining shows the position of the swimmer.

To provide a further understanding of the invention, the following detail description illustrates embodiments and examples of the invention, this detailed description being provided only for illustration of the invention.

### BRIEF DESCRIPTION OF THE DRAWINGS

The drawings included herein provide a further understanding of the invention. A brief introduction of the drawings is as follows:

FIG. 1 is a combination view of the conventional swimming goggles.

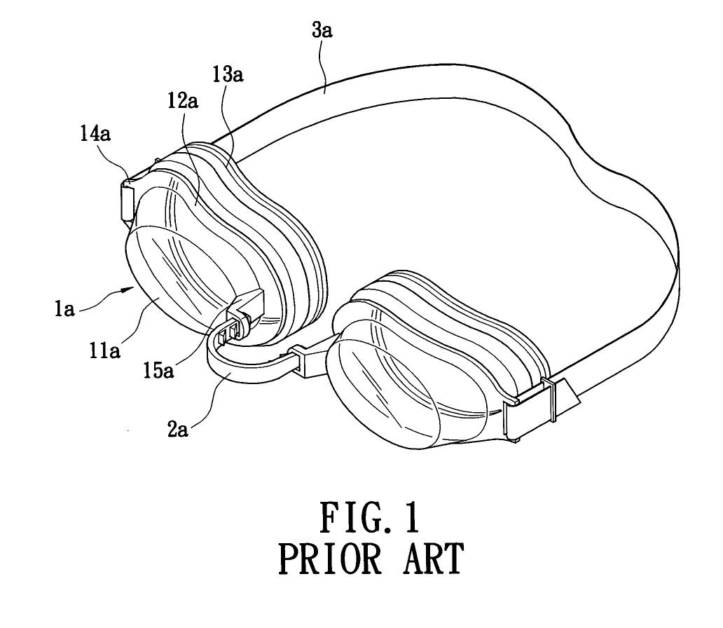

FIG. 2 is a partial exploded view of the shining swimming goggles in accordance with a preferred embodiment of the present invention.

FIG. 3 is a combination view of the shining swimming goggles in accordance with a preferred embodiment of the present invention.

FIG. 4 is a combination view of the shining swimming goggles in accordance with other one preferred embodiment of the present invention.

### DETAILED DESCRIPTION OF THE EMBODIMENTS

Referring now to the drawings wherein the showings are for purposes of illustrating preferred embodiments of the present invention only, and not for purposes of limiting the same.

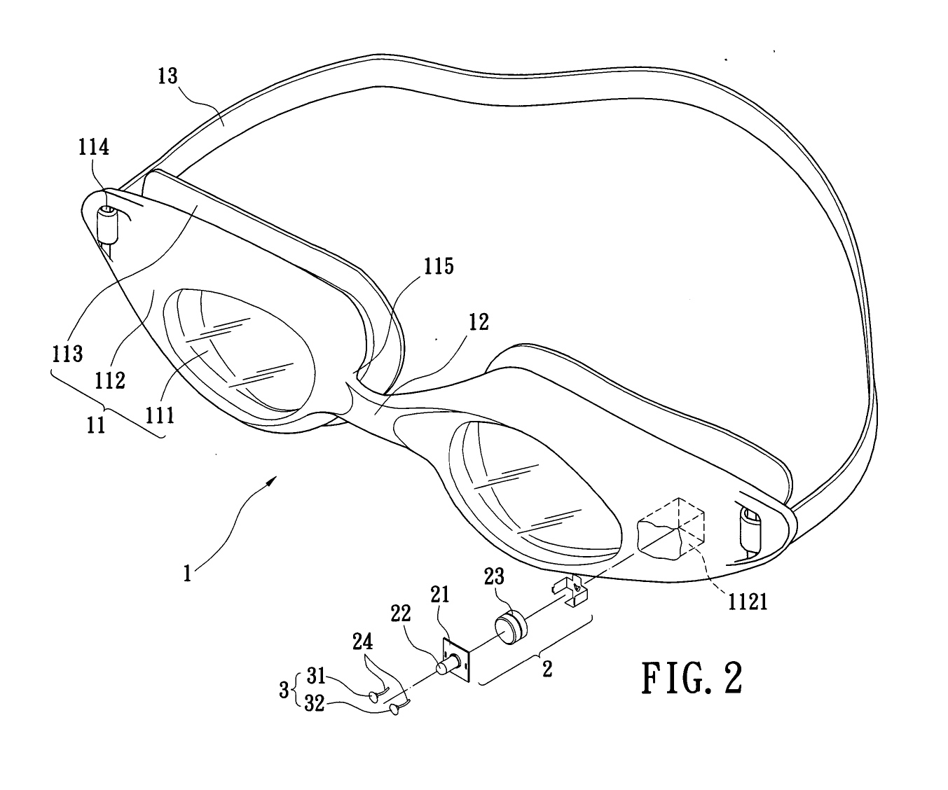

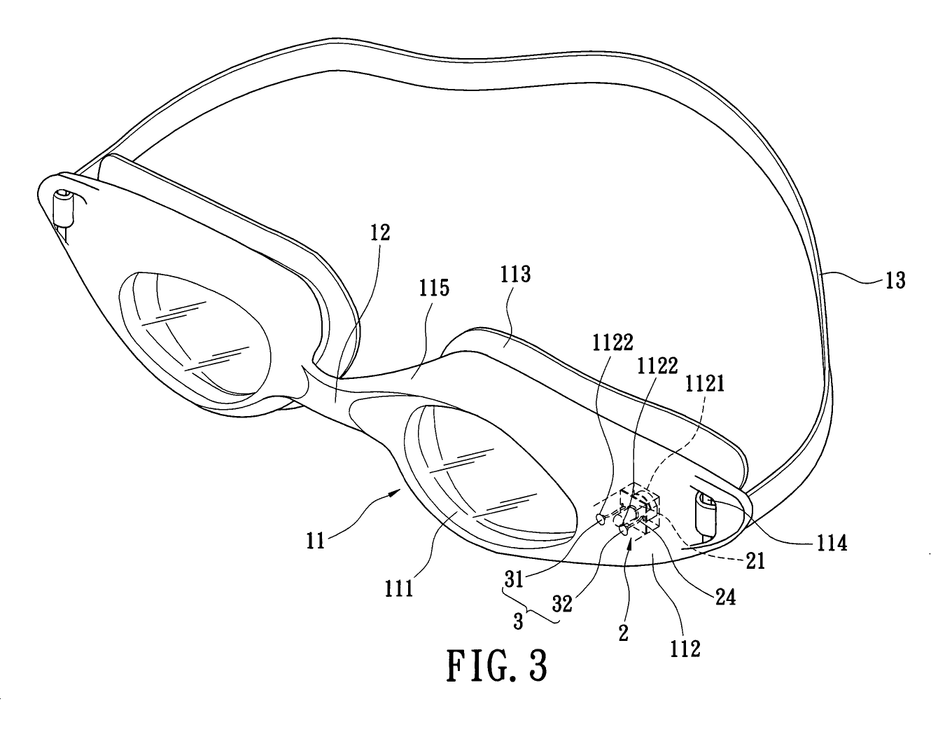

Referring to the drawings, and initially to FIGS. 2-3, a pair of shining swimming goggles in accordance with a preferred embodiment of the present invention comprises a pair of swimming goggles 1, a shining module 2 and an electric conducting portion 3. The shining module 2 is embedded in an inner portion of the swimming goggles 1. The electric conducting portion 3 has a first conducting portion 31 and a second conducting portion 32. The first conducting portion 31 and the second conducting portion 32 are respectively disposed on a surface of the swimming goggles 1 and electrically connected to the shining module 2. Thereby when the swimming goggles 1 are placed in water they cause the electric conducting portion 3 to conduct power, and the shining module 2 shines for showing the position of a swimmer.

The swimming goggles 1 comprise a pair of lens bodies 11, a bridge component 12 and a headband 13. The two lens bodies 11 are left and right symmetric. Each of the two lens bodies 11 further comprises a lens portion 111, a side frame portion 112 and a pad 113. The side frame portion 112 is integrally formed on the periphery of the lens portion 111. The pad 113 is disposed on one side of the periphery of the side frame portion 112. The side frame portion 112 has a receiving space 1121 at an inner portion thereof. And the side frame portion 112 has two apertures 1122 on the surface thereof. Each of the two apertures 1122 is disposed in the receiving space 1121. The receiving space 1121 is provided for the shining module 2 to be disposed therein. The two apertures 1122 are provided respectively for the first conducting portion 31 and the second conducting portion 32 of the electric conducting portion 3 to join together tightly therein. Two first fixing portions 114 are provided at the side frame portions 112 at the distant ends of the left and right lens bodies 11. Two second fixing portions 115 are provided at the side frame portions 112 at the adjacent ends of the left and right lens bodies 11. The two ends of the bridge component 12 are connected respectively to the two second fixings 115. The two ends of the headband 13 are connected respectively to the two first fixings 114.

The shining module 2 is embedded in the receiving space 1121. The shining module 2 includes a circuit unit 21, a shining element 22 and a power source 23. The circuit unit 21 is a PCB. The circuit unit 21 is electrically connected to the first conducting portion 31 and the second conducting portion 32 through two conducting wires 24 respectively. The shining element 22 is an LED. The positive pole and the negative pole of the LED are respectively electrically connected to the circuit unit 21. The power source 23 is an electric cell. The electric cell can be an alkaline cell. The positive pole and the negative pole of the electric cell are respectively electrically connected to the circuit unit 21 for providing electric power to the shining element 22 for shining.

The first conducting portion 31 and the second conducting portion 32 of the electric conducting portion 3 are the place the electric current of the negative pole flows through respectively. The first conducting portion 31 is electrically connected to the negative pole of the electric cell. The second conducting portion 32 is electrically connected to the negative pole of the LED. In the other words, the first conducting portion 31 and the second conducting portion 32 are formed through cutting off the circuit the electric current of the negative pole flows through. Therefore, the first conducting portion 31 and the second conducting portion 32 form a passageway of current to connect with each other.

The first conducting portion 31 of the electric conducting portion 3 is joined tightly in one of the two apertures 1122. One side face of the first conducting portion 31 is exposed on the surface of the side frame portion 112. The other side face of the first conducting portion 31 is exposed to the receiving space 1121 and electrically connected to the negative pole of the power source 23 through the conducting wire 24. The second conducting portion 32 of the electric conducting portion 3 is joined tightly in another one of the two apertures 1122. One side face of the second conducting portion 32 is exposed on the surface of the side frame portion 112. The other side face of the second conducting portion 32 is exposed to the receiving space 1121 and electrically connected to the negative pole of the shining element 22 through the conducting wire 24.

In addition, the first conducting portion 31 and the second conducting portion 32 of the electric conducting portion 3 can also be the place the electric current of the positive pole flows through respectively. The first conducting portion 31 is electrically connected to the positive pole of the electric cell. The second conducting portion 32 is electrically connected to the positive pole of the LED. In the other words, the first conducting portion 31 and the second conducting portion 32 are formed through cutting off the circuit the electric current of the positive pole flows through. Therefore, the first conducting portion 31 and the second conducting portion 32 form a passageway for current to connect with each other.

When a swimmer puts on the swimming goggles 1 and dives into water, the first conducting portion 31 and the second conducting portion 32 will conduct through the water and make the shining module 2 shine. If the swimmer has an accident in the water, a lifesaver can find the swimmer immediately.

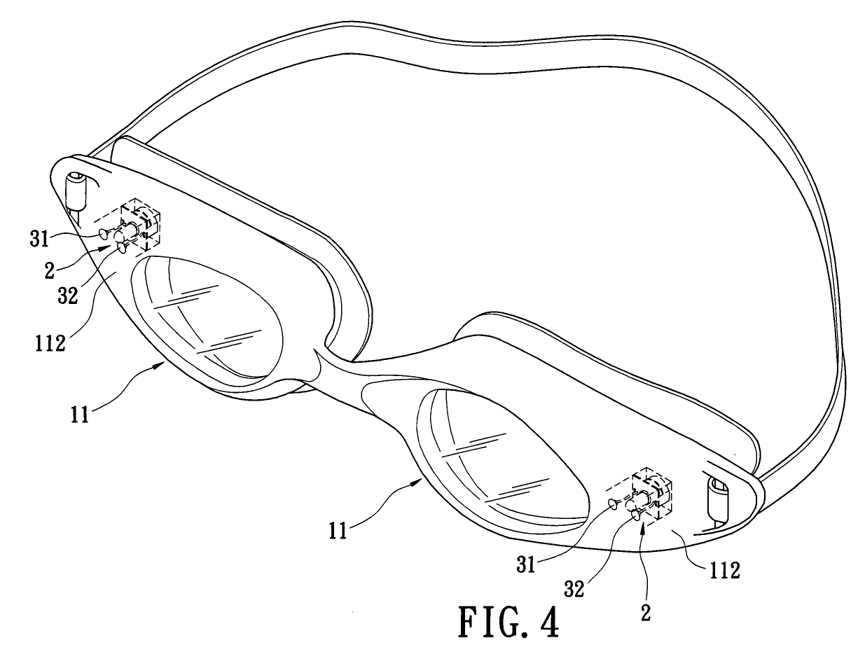

Referring to the drawings, and finally to FIG. 4, which is the combination view of the shining swimming goggles in accordance with another preferred embodiment of the present invention. Two shining modules 2 are embedded in the side frame portion 112 of the left and right of the two lens bodies 11 respectively to form two symmetric shining sources, thereby the two symmetric shining sources intensify the light to increase the chances that the swimmer can be spotted in the water.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

What is claimed is:

1. A pair of shining swimming goggles comprising:
a pair of swimming goggles;
a shining module embedded in the swimming goggles; and
an electric conducting portion disposed on a surface of the swimming goggles and electrically connected to the shining module; thereby when the swimming goggles are placed in water they cause the electric conducting portion to conduct electricity, and the shining module shines for showing a position of a swimmer.

2. The shining swimming goggles according to claim 1, wherein the shining module includes a circuit unit electrically connected to the electric conducting portion; a shining element electrically connected to the circuit unit; and a power source electrically connected to the circuit unit for providing electric power to the shining element so that it shines.

3. The shining swimming goggles according to claim 2, wherein the circuit unit is a PCB.

4. The shining swimming goggles according to claim 2, wherein the shining element is an LED.

5. The shining swimming goggles according to claim 2, wherein the power source is an electric cell.

6. The shining swimming goggles according to claim 2, wherein the electric conducting portion has a first conducting portion and a second conducting portion, the first conducting portion is electrically connected to a negative pole of the power source, and the second conducting portion is electrically connected to a negative pole of the shining element.

7. The shining swimming goggles according to claim 2, wherein the electric conducting portion has a first conducting portion and a second conducting portion, the first conducting portion is electrically connected to a positive pole of the power source, and the second conducting portion is electrically connected to a positive pole of the shining element.
